(19) United States
(12) Patent Application Publication
(10) Pub. No.: US 2005/0196258 A1
(43) Pub. Date: Sep. 8, 2005

(54) Interior Step Ladder Rack

(76) Inventor: Daniel Fredrick Stabs, Duluth, MN (US)

Correspondence Address: WILLIAM T. HELWIG, ATTORNEY AT LAW, RUDY LAW FIRM, 123 AVENUE C, CLOQUET, MN, 55720, US

(21) Appl. No.: 10/906,743

(22) Filed: Mar. 4, 2005

Related U.S. Application Data
(60) Provisional application No. 60/549,609, filed on Mar. 4, 2004.

(51) Int. Cl. B60P 9/00

(52) U.S. Cl. 414/462

(57) ABSTRACT

A ladder rack apparatus and method that allows a person to easily store a step ladder within the interior overhead space of a work vehicle. Generally, a sled-like design wherein the front of the rack is hingedly attached to the interior roofline with a latch provided at the rear for securing a step ladder in the overhead space. The ladder rack is accessed from the rear doors or liftgate of a vehicle. The rear latch is opened allowing the rear of the ladder rack to drop to a desired height. A step ladder is loaded onto or unloaded from the ladder rack. The rear of the ladder rack is raised back up to the interior roofline and latched in place. The interior step ladder rack is especially useful to service vehicle operators as an aid in freeing vehicle floor space without requiring the use of a roof top rack.

### BACKGROUND OF THE INVENTION

The present invention relates in general to a ladder rack apparatus and method for overhead storage of a step ladder, and in particular to an interior step ladder rack apparatus for overhead storage of a step ladder within the interior space of a service vehicle.

Ladders in general, and step ladders in particular, are often bulky and awkward to store. Usually ladders of any type are simply laid on the floor against a wall or suspended from the ceiling or wall on hooks. Even simple overhead hooks can be troublesome for storage of heavy stepladders, and their use still requires the floor space below them be kept clear for access to the ladder. For example, in order to lift a heavy step ladder onto overhead hooks, one must either stand and lift near the ladder's center or, with the help of an assistant, lift the ladder at opposite ends. In either case, it is necessary that the floor space below the hooks be clear or that the floor space at both ends be clear.

Ladders are a necessary tool of many service professions, which require their transportation to and from jobs. Many devices have been made for storing ladders on vans or trucks. Typically, these are exterior racks mounted on the roof of the vehicle. Such racks are relatively costly and inconvenient to use. They are not easy to reach and often require lifting heavy wooden ladders to the top of vehicles, resulting in occasional back injury. These racks are usually open and expose the ladder to adverse weather conditions such as sun, snow, or rain. Even if the ladder is made of a material which is not affected by extreme weather conditions, dirt and moisture accumulating on it will brush off on the user or be carried into interior work areas.

Ladder rack designs which mount on the side of a service vehicle tend to block access to side doors or storage compartments. Ladder rack designs which lower the ladder to an accessible height and retract for storage are bulky and expensive.

Numerous patents have been developed to aid in the storage and transportaion of ladders. Much of the prior art is focused on ladder racks which aid in the loading and unloading of ladders from the top of service vehicles. Some prior art is focused on greater securement of ladders from movement while being transported, attached to a ladder rack. Some prior art provides for interior storage of a ladder in a vehicle. Some prior art provides for use of a moving track to aid in the loading and unloading of a ladder. None of the prior art provides an overhead storage rack for securing a ladder for transportation and storage within the vehicle interior. None of the prior art uses an interior overhead storage rack which provides easy access from the rear doors or liftgate of a vehicle. None of the prior art uses a design which allows for a heavy ladder to be slid up into storage position while the rack carries the entire weight of the ladder. None of the prior art uses a design where a single simple latching device completely secures the ladder rack and any ladder stored thereon for transportion.

U.S. Pat. No. 6,827,541 issued Dec. 7, 2004 to Ziaylek et al. is a power assisted ladder rack which provides for loading low on the side of a vehicle with a hydraulic power assist to move the rack to a storage position high on the side of a vehicle. This ladder rack apparatus is heavy, expensive, requires powered hydraulics to operate, and is designed primarily for use on emergency vehicles, and is not designed to provide simple interior storage of a ladder in a vehicle.

U.S. Pat. No. 6,764,268 issued Jul. 20, 2004 to Levi is a ladder rack which uses a mechanical leverage design to provide ladder loading on the side of a vehicle and a manual or power driven rotatable drive shaft to retract the rack to a roof top position. This ladder rack apparatus provides for exterior storage of a ladder using complex moving parts, and is not designed to provide simple interior storage of a ladder in a vehicle.

U.S. Pat. No. 5,651,484 issued Jul. 29, 1997 to Fugman, U.S. Pat. No. 5,137,320 issued Aug. 11, 1992 to Christensen, and U.S. Pat. No. 4,751,981 issued Jun. 21, 1988 to Mitchell et al. are examples of ladder racks designed to attach directly to a pickup truck box or to a truck rack attached to a pickup truck box. These ladder rack apparatus's provide for exterior storage of a ladder on a vehicle and require high lifting of ladders for storage on such racks. These designs do not provide for safe, low height lifting or simple interior storage of a ladder in a vehicle.

U.S. Pat. No. 4,008,838 issued Feb. 22, 1977 to Correll is a ladder rack designed to carry ladders on top of van-type vehicles, and includes a mechanical lever hook system to secure a ladder to the rack. This ladder rack apparatus provides for exterior storage of a ladder on a vehicle roof-top, and require high lifting of a ladder for storage on the rack. This design does not provide for safe, low height lifting or simple interior storage of a ladder in a vehicle.

U.S. Pat. No. 5,498,048 issued Mar. 12, 1996 to Shelby, Jr. is a cargo van designed to provide storage areas for work tools, equipment and supplies. This patent provides for a raised platform floor above the van floor, and provides for storage of a ladder in the space created between the raised platform floor and the van floor. This design does not provide for overhead storage of a ladder within the vehicle interior and does not provide for visual inspection of the ladder without complete removal from the vehicle.

U.S. Pat. No. 5,402,979 issued Apr. 4, 1995 to Bellamy is an overhead storage apparatus which uses a storage hook on track design for hanging elongated objects such as ladders, pipes or lumber. This storage apparatus may be used for interior overhead storage of a ladder in a van. When used in a vehicle, this storage apparatus will allow a hanging ladder to swing. This storage apparatus requires careful maneuvering when placing the front end of the ladder on the carriage hook, so as not to slide the carriage hook away from the ladder before it is caught on the hook. Likewise, once the front end of the ladder is caught on the carriage hook, the entire weight of the rear half of the ladder must be lifted to shoulder height and carried forward until the carriage hook reaches the front end of the track so that the back of the ladder can be caught by the rear fixed hook, only then may the weight of the ladder be released without dropping the rear end of the ladder. This storage apparatus does not provide for a design within which a step ladder may be secured from movement for transportation. This storage apparatus does not provide for a design which allows quick and easy placement of a step ladder on the apparatus. This storage apparatus does not provide for a design which allows for a heavy ladder to be slid up into storage position, while the apparatus carries the entire weight of the ladder.

What is needed then, is a ladder rack apparatus which is simple and easy to use, which provides for interior overhead storage of a step ladder in a service vehicle, which secures a step ladder from movement for transportation, which provides for quick and easy placement of a ladder on the ladder rack, and which allows for a heavy ladder to be slid up into storage position while the ladder rack carries the entire weight of the ladder.

### SUMMARY OF THE INVENTION

It is an object of the present invention to provide a ladder rack apparatus which allows loading and unloading of a ladder from a vehicle to occur in a timely and cost effective manner.

It is another object of the present invention to provide a ladder rack apparatus which is simple and easy to use.

It is a further object of the present invention to provide a ladder rack apparatus which provides for interior overhead storage of a step ladder in a service vehicle.

It is another object of the present invention to provide a ladder rack apparatus which secures a step ladder from movement for transportation.

It is a further object of the present invention to provide a ladder rack apparatus which provides for quick and easy placement of a ladder on the ladder rack.

It is another object of the present invention to provide a ladder rack apparatus which is inexpensive compared to prior art.

It is yet a further object of the present invention to provide a ladder rack apparatus which allows for a heavy ladder to be slid up into storage position while the ladder rack carries the entire weight of the ladder.

These and other objects and advantages of the present invention are realized in one embodiment of an interior step ladder rack apparatus for overhead storage of a step ladder in a vehicle interior, comprising, a ladder rack mounting assembly, the interior roofline structural ribs of said vehicle to which said ladder rack mounting assembly is attached, a ladder rack tube frame, two rack frame pivot plates attached to the front ends of said ladder rack tube frame, a pivot hole through each said pivot plate, a pivot bolt which extends through said pivot holes, attaching said ladder rack tube frame to said ladder rack mounting assembly, ladder rack retention cable assembly attaching said ladder rack tube frame from a central location on each side of said ladder rack tube frame to said interior roofline structural ribs of said vehicle, and a ladder securement assembly attaching said ladder rack tube frame from the rear end of said ladder rack tube frame to said interior roofline structural ribs of said vehicle.

Generally, a sled-like design wherein the front of the rack is hingedly attached to the interior roofline ribs with a latch provided at the rear for securing a step ladder in the overhead space. The ladder rack is accessed from the rear doors or liftgate of a vehicle. The rear latch is opened allowing the rear of the ladder rack to drop to a desired height. A step ladder is loaded onto or unloaded from the ladder rack. The rear of the ladder rack is raised back up to the interior roofline and latched in place. The interior step ladder rack is especially useful to service vehicle operators as an aid in freeing vehicle floor space without requiring the use of a roof top rack.

Other objects and features of the invention will become clear upon a reading of the Detailed Description.

### BRIEF DECSRIPTION OF THE DRAWINGS

The present invention may be understood from the description of the embodiment which follows and from the accompanying drawings. The drawings are hereby expressly made a part of the specification.

FIG. 1 is an isometric view of the interior step ladder rack apparatus, as it would appear installed in a service van and while carrying a step ladder in the closed or storage position.

FIG. 2 is a side view of the ladder rack apparatus depicted in FIG. 1, as it would appear while carrying a step ladder in the closed or storage position, with the dashed lines indicating how the ladder rack apparatus would appear in the open position for loading or unloading.

FIG. 3 is a front view of the ladder rack apparatus depicted in FIG. 1, as it would appear while in the closed position.

FIG. 4 is an overhead view of the ladder rack apparatus depicted in FIG. 1, as it would appear while carrying a step ladder in the closed or storage position.

FIG. 5 is a side view of the interior step ladder rack apparatus, as it would appear in an alternate installation in a pickup truck topper, and while carrying a step ladder in the closed or storage position, and indicating by outline the open position.

FIG. 6A is an enlarged side view of the ladder rack securement assembly of the ladder rack apparatus depicted in FIG. 5.

FIG. 6B is an enlarged side view of the ladder rack retention cable assembly of the ladder rack apparatus depicted in FIG. 5.

FIG. 6C is an enlarged side view of the ladder rack mounting assembly of the ladder rack apparatus depicted in FIG. 5.

FIG. 7 is a rear view of the interior step ladder rack apparatus, as it would appear installed and centered on the midline of the interior roof in a service van.

FIG. 8 is a rear view of the interior step ladder rack apparatus, as it would appear installed and offset to the left side of the the midline of the interior roof in a service van.

FIG. 9 is a side view of the ladder rack apparatus depicted in FIG. 8, as it would appear installed and offset to the left side of the the midline of the interior roof in a service van.

FIG. 10 is an enlarged side view of the ladder rack offset mounting assembly of the ladder rack apparatus depicted in FIG. 9.

### DETAILED DESCRIPTION OF THE PREFERRED EMBODIMENT

Reference is made herein to the attached drawings. Like reference numerals are used throughout the various drawings to depict like or similar elements of the claimed ladder rack apparatus. For the purpose of presenting a brief and clear discussion of the ladder rack apparatus, the preferred embodiment will be discussed in conjunction with use in a service vehicle. This is for representative purposes only and should not be construed as limiting in any manner.

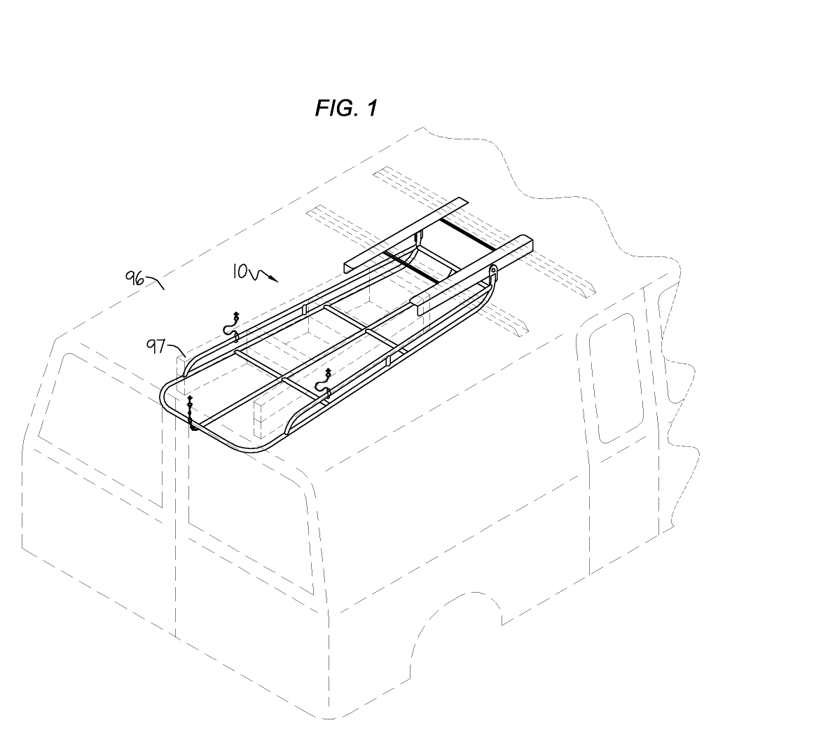

Referring now to FIG. 1, the preferred embodiment 10 of the ladder rack apparatus, is seen as positioned in the rear of a service van 96 with a ladder 97 in the closed or storage position.

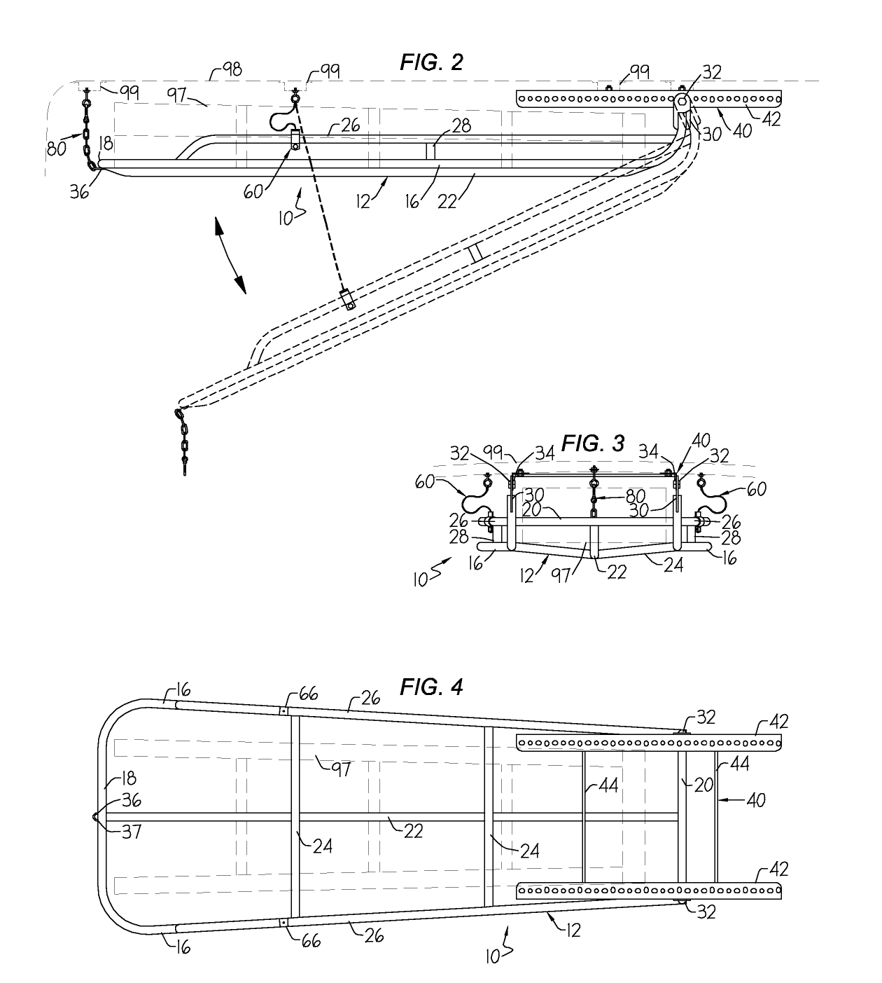

FIGS. 2, 3 and 4 provide greater detail of the ladder rack apparatus 10 with its primary assemblies: the ladder rack tube frame 12, which provides support for a ladder 97 which is stored on the ladder rack apparatus 10; the mounting assembly 40 which attaches to the service van's interior structural ribs 99, underneath the van's interior roofline 98, and is pivotally attached to the ladder rack tube frame 12 by pivot bolts 32; the retention cable assembly 60 which attaches from the sides of the ladder rack tube frame 12 to the overhead structural roof ribs 99; and the securement assembly 80 which attaches from the loading end of the ladder rack tube frame 12 to an overhead structural roof rib 99.

The ladder rack tube frame 12 is comprised of a pair of outer frame side tubes 16 which are joined by an outer frame rear tube 18, at the loading end of ladder rack apparatus 10, and are joined at the pivot end by a front cross tube 20. Cross brace tubes 24 and center frame tube 22, which connects centrally to the outer frame rear tube 18 and front cross tube 20, and also connects with cross brace tubes 24, which connect the outer frame side tubes 16 to each other at approximately one third and two thirds of their length, provide the supporting structure upon which the ladder 97 rests, as can be seen in FIG. 4. Siderail tubes 26 and siderail tube brace 28, as can be seen in FIG. 2, provide additional rigidity to the ladder rack tube frame 12, and while preventing the ladder from sideways movement during loading or transport.

FIG. 3 provides a front view of the ladder rack apparatus 10, from which can be seen pivot bolts 32 and pivot nuts 34, which extend through pivot plates 30 which are attached to the upward turned ends of outer frame side tubes 16, as can be seen in FIG. 2. The pivot bolts 32 provide the pivot point about which the ladder rack tube frame 12 rotates, as can be seen in FIG. 2, when being lowered from the closed or storage position to the open or loading position. It is also seen that angle mounting brackets 42 attach to interior roofline structural ribs 99, and are connected to each other by square tube bracket braces 44 as seen in FIG. 4. Pivot bolts 32 are also seen attaching the pivot plates 30 to the angle mounting brackets 42.

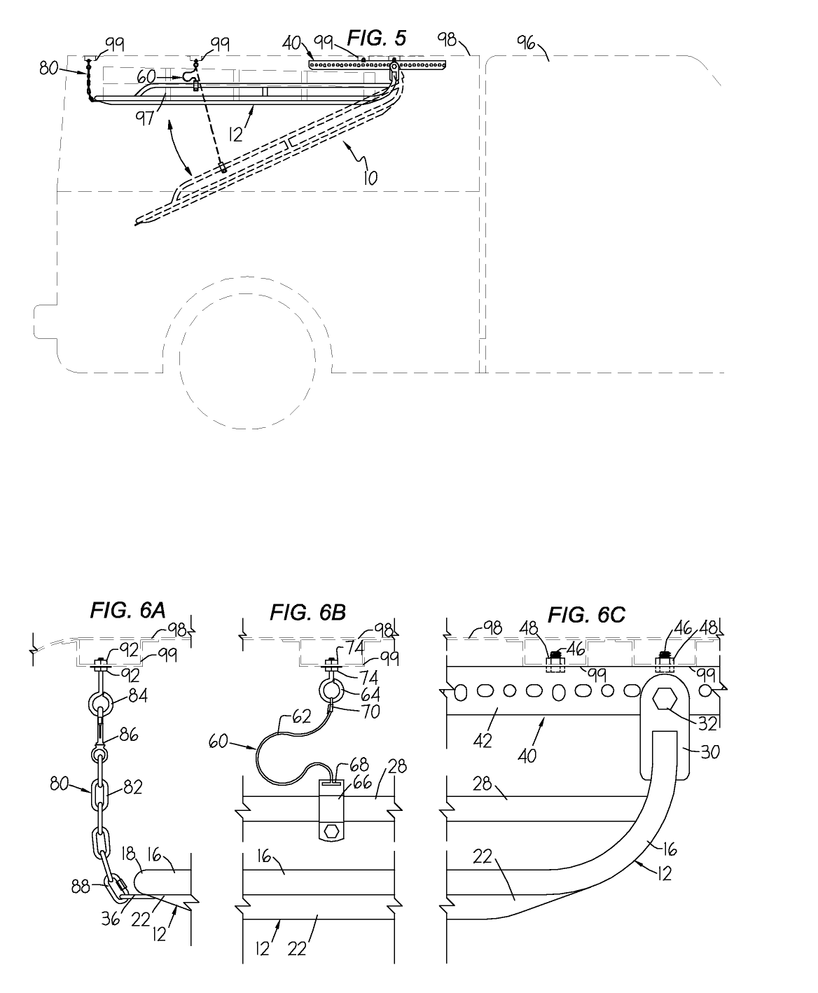

FIG. 5 provides a side view of an interior step ladder rack apparatus, as it would appear in an alternate installation in a pickup truck topper.

FIGS. 6A, 6B and 6C provide enlarged detail views of the various assemblies seen in FIG. 5.

FIG. 6A is a detail view of the securement assembly 80 which attaches to the ladder rack frame tube 12 by a securement bracket 36 being centrally located on the outer frame rear tube 80 at the loading end of said ladder rack frame tube 12. Securement chain 82 is attached to the securement bracket 36 by a break apart link 88, and is of sufficient strength to support the ladder rack tube frame and a ladder stored thereon while in the closed or storage position. Securement chain 82 attaches to eyebolt 84 by a releaseable snap hook 86, wherein said eyebolt 84 is fastened to overhead structural rib 99 by eyebolt nuts 92.

FIG. 6B is a detail view of the retention cable assembly 60 which attaches to the ladder rack frame tube 12 by a a tube clamp 66 attached to each siderail tube 26 with a retention cable 62 attached to each tube clamp 66 by cable anchor 68 attached to the end of retention cable 62, the retention cables being of sufficient strength to support the ladder rack tube frame and a ladder stored thereon while in the open or loading position at a desired loading height. Retention cable 62 attaches to eyebolt 64 with the use of compression ferrule 70, wherein said eyebolt 64 is fastened to overhead structural rib 99 by eyebolt nuts 74.

FIG. 6C is a detail view of the mounting assembly 40 attachment to the overhead structural rib 99 by mounting bolts 46 and mounting nuts 48, which bolts 46 pass through angle mounting brackets 42 bolting them to the overhead structural ribs 99.

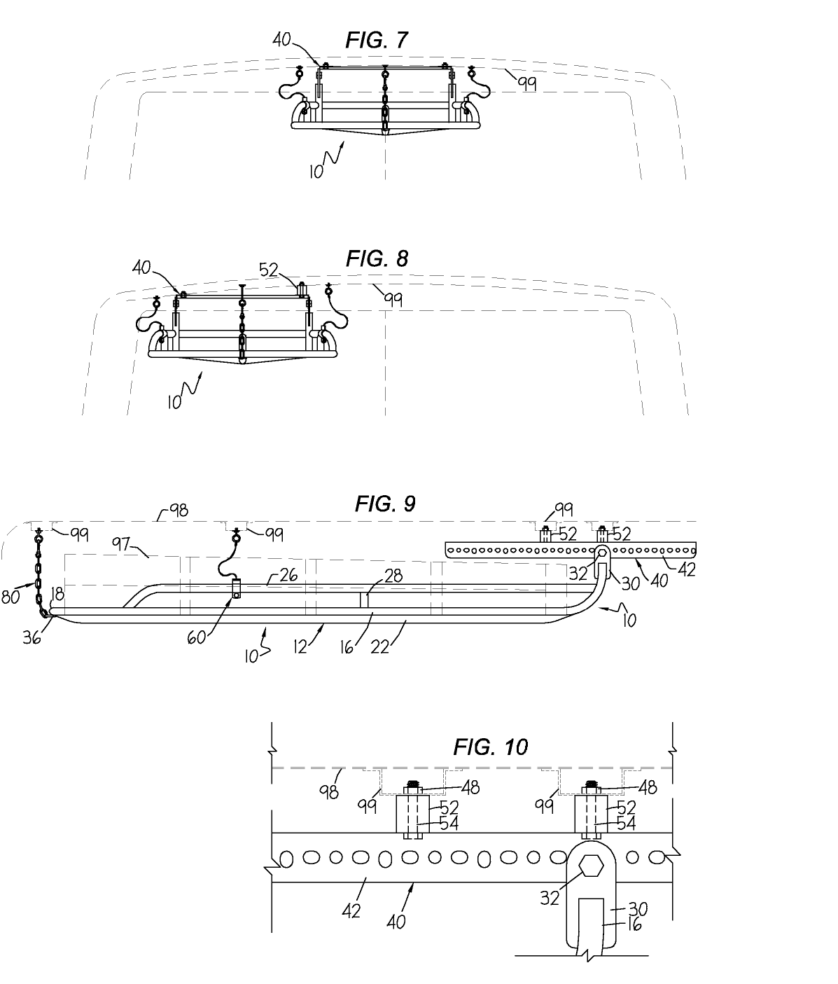

FIG. 7 is a rear view of the ladder rack apparatus 10 centrally installed in a van.

FIGS. 8, 9 and 10 provide a rear, side and detail view of a ladder rack apparatus 10 in a offset installation requiring the use of offset mounting spacers 52 and offset mounting bolts 54 on the inboard side during installation to facilitate keeping the ladder rack apparatus 10 in a level position. The ladder rack apparatus can be offset to the left or to the right on the ceiling of a van by use of the mounting spacers on the inboard side. Offset mounting can allow access to the ladder rack apparatus through the use of only one rear door.

The ladder rack apparatus can be constructed of steel, aluminium, wood, high strength plastics or other materials, it can be constructed in sizes to accommodate 2′, 4′, 6′, 8′, 10′ and 12′ step ladders or step ladders of any size where the ladder rack apparatus will fit within the enclosed space, and may be used in a construction trailer or on an ocean vessel, besides the primary use in a service van or pickup truck topper.

The method of the present invention includes the steps of providing a service vehicle which contains a properly installed interior step ladder rack apparatus for overhead storage of a step ladder, bringing a step ladder to the rear of said vehicle, opening the rear doors or liftgate of said vehicle for access to the ladder rack, unhooking the securement chain from the overhead securement eyebolt, pivoting the ladder rack tube frame downwards in relation to the ladder rack mounting assembly, lowering the rear end of the ladder rack tube frame by said pivot action until the ladder rack retention cables become taut, resting the ladder rack tube frame on the ladder rack retention cables, placing top end of step ladder on lowered rear end of ladder rack tube frame, sliding step ladder up the ladder rack tube frame, allowing the ladder rack tube frame to carry the weight of the ladder while the ladder is being loaded onto the rack, sliding the step ladder forward on the ladder rack tube frame until it comes to rest against the front cross tube, lifting the rear end of the ladder rack tube frame up into the closed or storage position, completing the step ladder securement procedure by hooking the securement chain to the overhead securement eyebolt, closing the rear doors of the vehicle, transporting the step ladder to a needed location. Reverse all actions for unloading of step ladder at service destination.

The method and embodiment of the present invention shown and discussed are by way of illustration and not of limitation, and a wide variety of equivalent methods and embodiments may be made without departing from the spirit or scope of the invention.

1. A step ladder rack apparatus for overhead storage of a step ladder, comprising:
an elongated support frame means which will support a step ladder for storage in an overhead location, having an attachment end and a loading end;
a pivot means attached to said attachment end of said support frame means to allow said loading end of said support frame means to be lowered downward to a desired loading height, while said pivot end of said support frame means pivots, allowing access to the support frame means for loading or removal of a step ladder stored thereon;
a mounting means attached to said pivot means for mounting said support frame means to an overhead surface and suspending said support frame means from said overhead surface;
a retention means attached to said support frame means by which said support frame means is supported at a desired loading height when said loading end of said support frame means is lowered; and,
a securement means attached to said support frame means by which said support frame means may be secured in the closed position for storage, or unsecured to allow said loading end of said support frame means to drop to the open position for loading.

2. The step ladder rack apparatus according to claim 1, wherein said support frame means is constructed of a light weight tube frame.

3. The step ladder rack apparatus according to claim 2, wherein said said support frame means includes light weight siderail tube braces running down each side of said support frame means for the prevention of ladder side movement and providing strength to the frame.

4. The step ladder rack apparatus according to claim 3, wherein said pivot means is comprised of a pivot plate attached to each side of said pivot end of said support frame means;
a pivot hole which penetrates each said pivot plate; and
a pivot bolt which extends through each said pivot hole in each said pivot plate, attaching said support frame means to said mounting means, and upon which said support frame means may pivot.

5. The step ladder rack apparatus according to claim 4, wherein said mounting means is comprised of parallel lengths of perforated angle bracket, for universal mounting to the structural frame of an overhead surface, properly spaced to allow a stored ladder to fit widthwise in between them when said ladder is supported on said support frame means;
lightweight crossbraces perpendicular to said angle brackets and of a proper length to attach said lengths of angle brackets together; and,
spacer means for use under one side of said mounting means, for use when an uneven or sloping structural frame of said overhead surface is encountered.

6. The step ladder rack apparatus according to claim 5, wherein said retention means is comprised of a tube clamp centrally attached to each side of said support frame means;
a retention cable attached to each said tube clamp, said cables being of sufficient strength to support said support frame means and a ladder stored thereon while in the open or loading position at a desired loading height; and
an eyebolt fastener means attaching the opposite end of each said cable to said structural frame of said overhead surface for load bearing in the open or loading position.

7. The step ladder rack apparatus according to claim 6, wherein said securement means is comprised of a securement bracket attached to said loading end of said support frame means;
a securement chain attached to said securement bracket, said securement chain being of sufficient strength to support said support frame means and a ladder stored thereon while in the closed or storage position; and
a releaseable fastener means attaching the opposite end of said securement chain to said structural frame of said overhead surface for load bearing in the closed or storage position.

8. The step ladder rack apparatus according to claim 7, wherein said securement chain includes a break apart chain link attached to said securement bracket for easy ajustment of chain length; and
wherein said releaseable fastener means is comprised of a snap hook; and
an eyebolt fastener means attached to said structural frame of said overhead surface, and to which said snap hook is releaseably attached.

9. A method for interior overhead storage of a step ladder in a vehicle, comprising:
providing a service vehicle which contains a properly installed interior step ladder rack apparatus for overhead storage of a step ladder;
bringing a step ladder to the rear of said vehicle;
opening the rear doors or liftgate of said vehicle for access to said ladder rack apparatus;
unhooking said securement chain from said overhead securement eyebolt;
pivoting said ladder rack tube frame downwards in relation to said ladder rack mounting assembly;
lowering said loading end of said ladder rack tube frame by said pivot action until said ladder rack retention cables become taut;
resting said ladder rack tube frame on said ladder rack retention cables;
placing top end of step ladder on lowered loading end of said ladder rack tube frame;
sliding step ladder up said ladder rack tube frame;
allowing said ladder rack tube frame to carry the weight of the ladder while the ladder is being loaded onto the rack;
sliding the step ladder forward on said ladder rack tube frame until it comes to rest against the front cross tube;
lifting the loading end of said ladder rack tube frame up into the closed or storage position;
completing the step ladder securement procedure by hooking said securement chain to said overhead securement eyebolt;
closing the rear doors of the vehicle;
transporting the step ladder to a needed location; and,
reversing all actions for unloading of step ladder at service destination.
